(19) United States
(12) Patent Application Publication
(10) Pub. No.: US 2015/0046208 A1
(43) Pub. Date: Feb. 12, 2015

(54) Systems and methods for the computer implemented management of business tasks

(71) Applicant: Omar Hatamleh, League City, TX (US)

(72) Inventor: Omar Hatamleh, League City, TX (US)

(73) Assignee: E-Appointments, Inc., League City, TX (US)

(21) Appl. No.: 13/960,765

(22) Filed: Aug. 6, 2013

(51) Int. Cl. G06Q 10/10

(52) U.S. Cl. CPC G06Q 10/1095
USPC 705/7.19

(57) ABSTRACT

Systems and methods for filling one or more available appointment windows. The methods can include communicating, by a computer, one or more available appointment windows to one or more existing and/or potential customers wherein at least one appointment window specific discount is associated with at least one of the one or more available appointment windows; receiving, by the computer, an acceptance by one or more of the existing and/or potential customers of one or more of the available appointment windows associated with the at least one appointment window specific discount. The systems can include a processor; a non-transitory memory in electronic communication with the processor; and one or more code sets stored in the non-transitory memory, the code sets being executable by the processor to at least associate each of at least one appointment window specific discounts with a customer account.

### BACKGROUND

1. Field

Embodiments described herein generally relate to systems and methods for the computer implemented management of business tasks.

2. Description of the Related Art

Business people manage their business and seek to improve their customer base through various tools and techniques. Typical tools include appointment and marketing management tools such as electronic calendars and various forms of advertising. Within those known tools, there are no computer-implemented tools that sufficiently meet business needs.

### SUMMARY

Systems and methods for filling one or more available appointment windows. The method can include communicating, by a computer, one or more available appointment windows to one or more existing and/or potential customers wherein at least one appointment window specific discount is associated with at least one of the one or more available appointment windows; receiving, by the computer, an acceptance by one or more of the existing and/or potential customers of one or more of the available appointment windows associated with the at least one appointment window specific discount.

The systems can include a processor; a non-transitory memory in electronic communication with the processor; and one or more code sets stored in the non-transitory memory, the code sets being executable by the processor to generate a scheduling calendar having one or more appointment windows displayed on an output device; schedule customer appointments within the one or more appointment windows; communicate one or more available appointment windows associated with at least one appointment window specific discount to one or more existing and/or potential customers; receive an acceptance by one or more of the existing and/or potential customers of one or more of the available appointment windows associated with the at least one appointment window specific discount; reserve on a first received basis the one or more appointment windows associated with the at least one appointment window specific discount for the one or more existing and/or potential customers from whom the acceptance was received; communicate to each of the one or more existing and/or potential customers, from whom the acceptance was received, confirmation of each of the one or more appointment windows associated with the at least one appointment window specific discount that were reserved for each of the one or more existing and/or potential customers; and associate each of the at least one appointment window specific discounts with a customer account corresponding to each of the one or more existing and/or potential customers who accepted and received a reservation for one or more of the appointment windows associated with the at least one appointment window specific discount.

### BRIEF DESCRIPTION OF THE DRAWINGS

FIG. 1 depicts a schematic of an illustrative business management system for, among other things, managing appointment calendars, marketing, and relationship and reputation management of a business, according to one or more embodiments described.

FIG. 2 depicts a schematic of an illustrative data management system for use with the illustrative business management system, according to one or more embodiments described.

FIG. 3 depicts an illustrative flow diagram for negotiating one or more appointment window specific discounts with one or more customers to fill one or more available appointment windows, according to one or more embodiments described.

FIG. 4 depicts an illustrative flow diagram for communicating appointment scheduling delays and schedule adjustments, according to one or more embodiments described.

FIG. 5 depicts an illustrative flow diagram for providing rescheduling of calendar appointments in the event of cancellations, according to one or more embodiments described.

### DETAILED DESCRIPTION

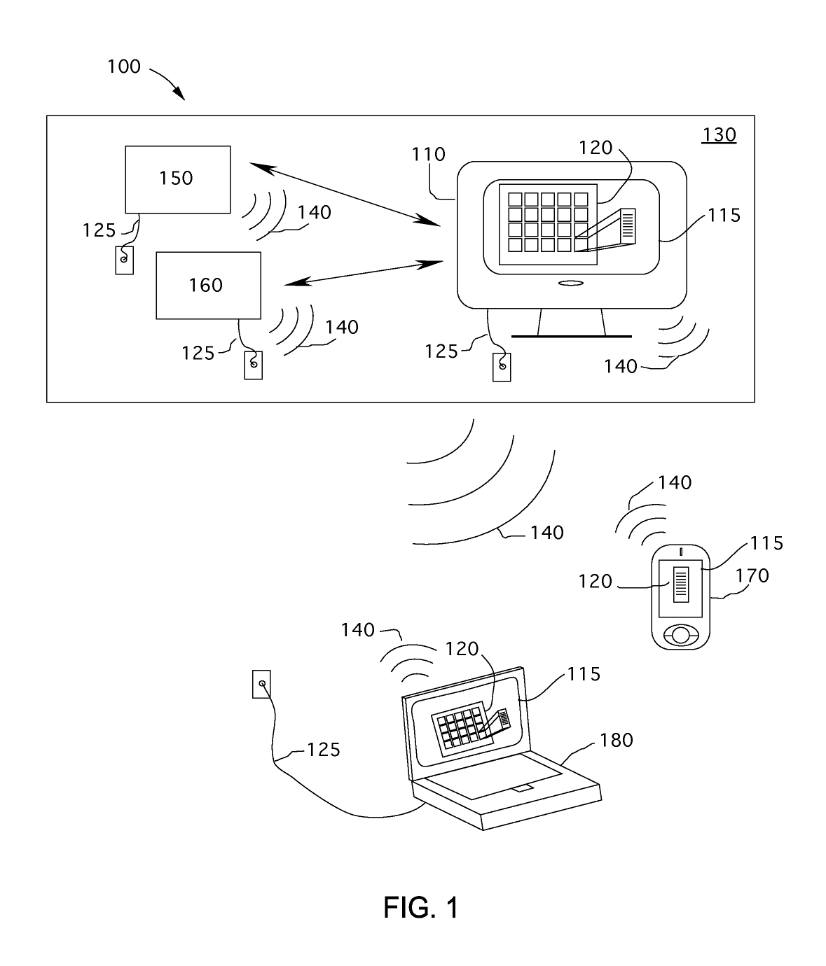

FIG. 1 depicts a schematic of an illustrative business management system 100 for, among other things, managing appointment calendars, marketing, and relationship and reputation management of a business 130, according to one or more embodiments. The business management system 100 can be used to manage the practice of a doctor, dentist, attorney, or other business person who regularly meets with any person, for example existing and/or potential customers. The systems and methods for business management of the business 130 discussed and described herein can form part of an information system, not shown, for providing customer information to individuals working within the business 130. For example, the systems and methods described herein can be integrated with electronic medical record systems, not shown, for utilization within the business 130.

The business management system 100 can include at least one computer 110 having an output device 115 on which can be displayed a graphical user interface 120 that can be utilized to manage aspects of the business 130. The computer 110 can receive, display and/or send any business entered information 150 to and from individuals working within the business 130 and/or existing and/or potential customers of the business 130. For example, an individual working within the business 130 can manage a dentist's or doctor's customer calendar by entering business entered information 150 into the computer 110. The business entered information 150 can include any data and/or electronic files created by one or more individuals working within the business 130 or any data and/or electronic files provided to one or more individuals working within the business 130.

The computer 110 can receive, display, and/or send customer provided information 160 to and from customers and to one or more individuals working within the business 130. The computer 110 can utilize personal communication devices, for example smart phone 170 and/or personal computer 180, to receive, display, and/or send the business entered information 150 and/or the customer provided information 160. The personal communication devices can also include personal computers 180, tablet PCs, hand held PCs, cellular phones, smart phones 170, hand held music players, or any other device or system having computing capabilities and/or any device capable of displaying information from, sending information to, and/or receiving information from the computer 110. The personal communication devices can operate as stand-alone devices or in combination with one or more “cloud” computing networks. The personal communications devices can operate using one or more available operating systems and can operate in combination with various software applications or “apps” designed for use with the one or more available operating systems.

The business entered information 150 and/or the customer provided information 160 can be transmitted between one or more computers 110, one or more smart phones 170, one or more personal computers 180, and/or one or more other device (not shown) via wireless source 140 and/or wired source 125. The wireless source 140 can be a radio frequency carrier wave upon which analog and/or digital information can be transmitted and/or any wireless communication system, for example one or more cellular communication systems. The wired source 125 can be one or more local area network connections, one or more telephone line connections, one or more Ethernet connections and/or one or more other wired communication connections. The wired source 125 and the wireless source 140 can be used independent of one another or in combination with one another.

The business entered information 150 and/or the customer provided information 160 can be displayed on the output device 115 via the graphical user interface 120. The graphical user interface 120 can include any combination of windows, icons, and/or menus displayed on the output device 115 that can be manipulated through human-computer interaction. For example, an appointment calendar, can be displayed on the output device 115 and manipulated via business entered information 150 and/or the customer provided information 160 via the graphical user interface 120. It should be noted that the graphics depicted in FIG. 1 as the graphical user interface 120 are non-limiting depictions and are provided for illustrative purposes only.

The computer 110 can be utilized to manage the business 130 through communication with customers. Utilizing one or more of the embodiments described herein, the computer 110 can execute software, embodiments of which are described herein below, that can generate, among other things, a scheduling calendar in combination with customer related information to schedule customer appointments for the business 130. The computer 110 can be utilized to inform customers about business 130 appointment delays, communicate discounts, such as appointment window specific discounts, to existing and/or potential customers, send business 130 news to customers and provide associated analytics and reports back to the business 130, perform search engine optimization (SEO) to improve internet search engine rankings for the business 130, send customized texts, provide demographic analysis and customer surveys, communicate appointment confirmations, communicate open appointments windows to existing and/or potential customers, provide wait list capabilities to fill cancellations, communicate notifications regarding overdue customers, communicate appointment window changes to customers, as well as other capabilities.

Search engine optimization (SEO) can include one or more processes for affecting the visibility of a website or a web page in a search engine's natural, un-paid, or organic search results. In general, the earlier or higher ranked on the search results page and more frequently a site appears in the search results list, the more visitors it will receive from the search engine's users. SEO can target different kinds of search engines, including image search, local search, video search, academic search, news search, and/or industry-specific vertical search engines.

As an Internet marketing strategy, SEO can consider how search engines work, what people search for, the actual search terms or keywords typed into search engines and which search engines are preferred by their targeted audience. Optimizing a website can involve editing its content, HTML and associated coding to both increase its relevance to specific keywords and to remove barriers to the indexing activities of search engines. Promoting a site to increase the number of backlinks, or inbound links, can be another SEO tactic. Other known techniques can be used for SEO.

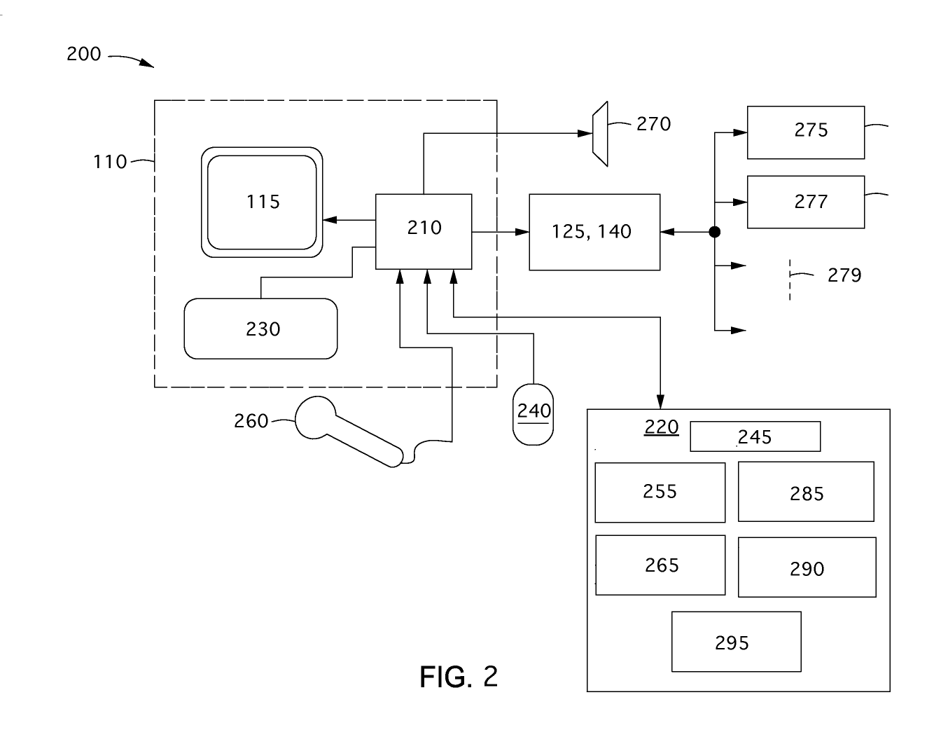

FIG. 2 depicts a schematic of an illustrative data management system 200 for use with the illustrative business management system 100, according to one or more embodiments. The system 200 can include one or more computers 110 that can include one or more central processing units 210, one or more input devices or keyboards 230, and one or more output devices 115, on which a software application can be executed. The one or more computers 110 can also include one or more memories 220 as well as additional input and output devices, for example a mouse 240, one or more microphones 260, and one or more speakers 270. The mouse 240, the one or more microphones 260, and the one or more speakers 270 can be used for, among other purposes, universal access and voice recognition or commanding. The one or more output devices 115 can be touch-sensitive to operate as an input device as well as a display device.

The one or more computers 110 can interface with database 277, support computer or processor 275, other databases and/or other processors 279, or the Internet via one or more wireless sources 140 and/or wired sources 125. It should be understood that the term “interface” does not indicate a limitation to interfaces that use only Ethernet connections and refers to all possible external interfaces, wired or wireless. It should also be understood that database 277, processor 275, and/or other databases and/or other processors 279 are not limited to interfacing with the one or more computers 110 utilizing one or more wireless sources 140 and/or wired sources 125 and can interface with one or more computers 110 in any means sufficient to create a communications path between the one or more computers 110 and database 277, processor 275, and/or other databases and/or other processors 279. For example, in one or more embodiments, database 277 can interface with one or more computers 110 via a USB interface while processor 275 can interface via some other high-speed data bus without using the one or more wireless sources 140 and/or wired sources 125. The one or more computers 110, the processor 275, and the other processors 279 can be integrated into a multiprocessor distributed system and/or one or more cloud computing systems.

It should be understood that even though the one or more computers 110 is shown in FIG. 1 and FIG. 2 as a platform on which the methods discussed and described herein can be performed, the methods discussed and described herein could be performed on any platform. For example, the many and varied embodiments discussed and described herein can be used on any device that has computing capability. For example, the computing capability can include the capability to access communications bus protocols such that a user can interact with the many and varied computers 110, processors 275, and/or other databases and processors 279 that can be distributed or otherwise assembled. These computing capabilities can include, but are not limited to, supercomputers, arrayed server networks, arrayed memory networks, arrayed computer networks, distributed server networks, distributed memory networks, distributed computer networks, “cloud” computing networks, one or more personal computers 180, tablet PCs, hand held PCs, devices sold under the trademark names BLACKBERRY™ or PALM™, cellular phones, smart phones 170, hand held music players, or any other device or system having computing capabilities.

Referring again to FIG. 2, programs can be stored in the one or more memories 220 and the one or more central processing units 210 can work in concert with at least the one or more memories 220, the one or more input devices 230, and the one or more output devices 115 to perform tasks for the user. In one or more embodiments, the one or more memories 220 can include any number and combination of non-transitory memory devices, without limitation, as is currently available or can become available in the art. In one or more embodiments, memory devices can include without limitation, and for illustrative purposes only: database 277, other databases and/or processors 279, hard drives, disk drives, random access memory, read only memory, electronically erasable programmable read only memory, flash memory, thumb drive memory, and any other memory device. Those skilled in the art are familiar with the many variations that can be employed using memory devices and no limitations should be imposed on the embodiments herein due to memory device configurations and/or algorithm prosecution techniques.

The one or more memories 220 can store an operating system (OS) 245, a business management agent 255, an appointment window discount agent 265, a sliding appointment window agent 285, a rescheduling agent 290, and/or a customer to professional paging agent 295. The operating system 245 can facilitate control and execution of software using the one or more central processing units 210. Any available operating system 245 can be used in this manner including WINDOWS™, LINUX™, Apple OS™, UNIX™, and the like.

The one or more central processing units 210 can execute either from a user request or automatically. In one or more embodiments, the one or more central processing units 210 can execute the business management agent 255, the appointment window discount agent 265, the sliding appointment window agent 285, the rescheduling agent 290, and/or the customer to professional paging agent 295 when a user requests, among other requests, to manipulate appointments on an appointment calendar, to communicate an appointment window specific discount, to send one or more messages to one or more business professionals, to send marketing materials to existing and/or potential customers, to perform SEO, and/or to perform other reputation and/or relationship management tasks.

Referring to both FIG. 1 and FIG. 2, managing appointments, manipulating appointments on an appointment calendar, communicating an appointment window specific discount, sending one or more messages to one or more business professionals, sending marketing materials, performing SEO, and/or performing reputation and/or relationship management tasks can include one or more of the capabilities of the business management agent 255, the appointment window discount agent 265, the sliding appointment window agent 285, the rescheduling agent 290, and/or the customer to professional paging agent 295. The communications can take place via e-mail and/or Short Messaging Services (SMS) and/or other known techniques. For example, the business management agent 255 can, among other things, generate a scheduling calendar including appointment windows in combination with customer related information to schedule customer appointments for the business 130, the scheduling calendar and appointment windows can be displayed within an internet browser window displayed on the output device 115, send business 130 news to customers and provide associated analytics and reports back to the business 130, improve internet search engine rankings for the business 130, send customized texts, provide demographic analysis and customer surveys, provide appointment confirmations, communicate open or available appointment windows to existing and/or potential customers, provide wait list capabilities to fill cancellations, send notifications regarding overdue customers, as well as other capabilities. The appointment window discount agent 265 can communicate one or more discounts to existing and/or potential customers and/or can target one or more appointment window specific discounts to existing and/or potential customers to entice customers to fill available appointment windows. The sliding appointment window agent 285 can be utilized to inform customers about business 130 appointment delays. The rescheduling agent 290 can notify customers of appointment window changes and negotiate a rescheduled appointment with one or more customers. The business management agent 255, the appointment window discount agent 265, the sliding appointment window agent 285, the rescheduling agent 290, and/or the customer to professional paging agent 295 can be operated on by the business entered information 150 and/or the customer provided information 160.

It should be noted that the business management agent 255, the appointment window discount agent 265, the sliding appointment window agent 285, the rescheduling agent 290, and/or the customer to professional paging agent 295 can be fully autonomous code sets, partially integrated code sets, or fully integrated code sets and no limitations should be construed from the depiction of the business management agent 255, the appointment window discount agent 265, the sliding appointment window agent 285, the rescheduling agent 290, and/or the customer to professional paging agent 295 as separate agents. It should also be noted that it is not necessary to execute the business management agent 255, the appointment window discount agent 265, the sliding appointment window agent 285, the rescheduling agent 290, and/or the customer to professional paging agent 295 simultaneously nor is it necessary to execute the various agents on the same one or more computers 110.

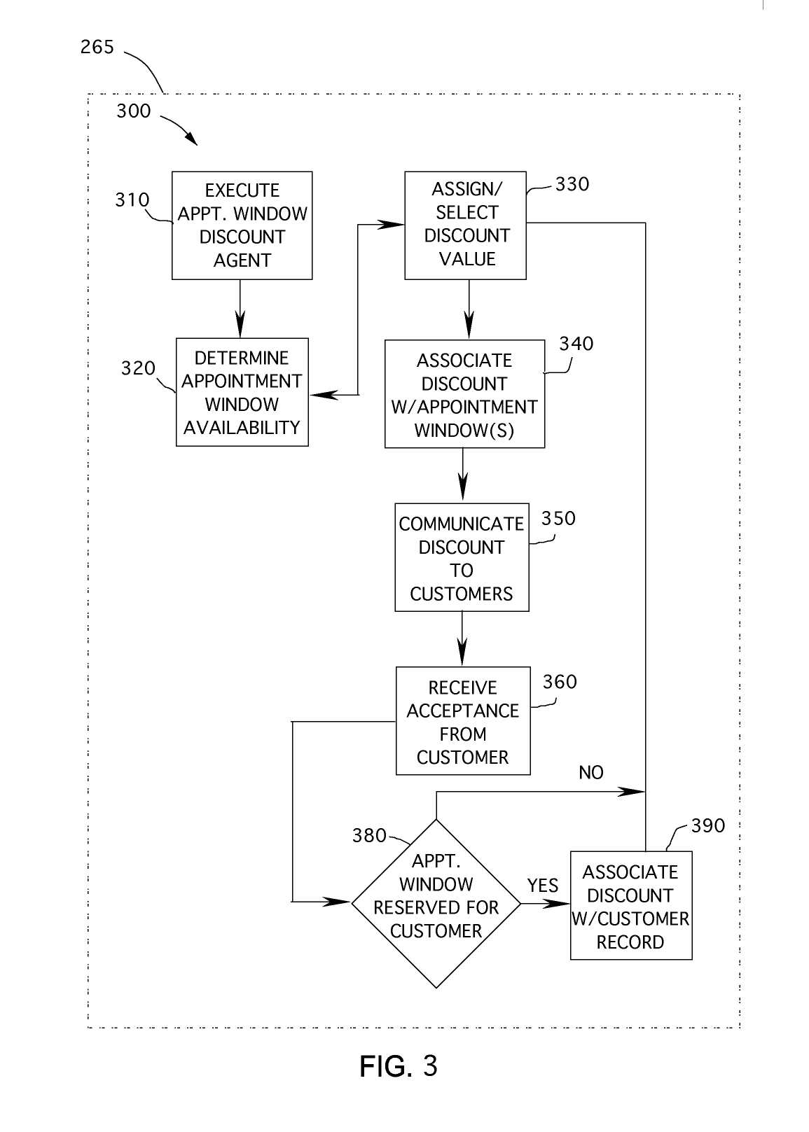

FIG. 3 depicts an illustrative flow diagram 300 for negotiating one or more appointment window specific discounts with one or more customers to fill one or more available appointment windows, according to one or more embodiments. The appointment window discount agent 265 can be executed 310. One or more available appointment windows can be determined 320 and appointment window specific discounts values can be assigned or selected 320 for one or more of the available appointment windows. The one or more appointment window specific discounts can be associated 340 with one or more of the available appointment windows. Communications in the form of one or more messages can be sent to one or more existing and/or potential customers 350 to inform the one or more existing and/or potential customers of the one or more available appointment windows 320 and the one or more discounts associated 340 with at least one of the one or more available appointment windows 320. The one or more existing and/or potential customers can respond to the communicated discount 350 to accept the appointment window. The acceptance can be received 360 and at least one of the available appointment windows 320 associated with at least one of the appointment window specific discounts 340 can be reserved on a first received basis for the existing and/or potential customer whose acceptance was first received. A confirmation can be sent to the one or more existing and/or potential customers who receive a reservation. The corresponding one or more associated appointment window specific discounts 340 can be associated with a customer record 390 of the existing and/or potential customer for whom the one or more appointment windows was reserved 380. One or more customer information forms can be sent to the one or more existing and/or potential customers who receive a reservation. The customer information forms can be completed by each of the customers who receive a reservation in preparation for their particular appointment. Step 320 through 390 can be repeated as often as desired until the one or more available appointment windows 320 are filled or new appointment windows are identified for one or more discounts and filled.

Still referring to FIG. 3, the appointment window discount agent 265 can be autonomously executed and/or user executed 310 to discretely or continuously search for available appointment windows 320. For example, if there are three half-hour long appointment windows available sometime in the future, one or more discounts can be associated with each of the three half-hour long appointment windows. The discounts can be communicated to one or more existing and/or potential customers who can accept at least one of the discounts by scheduling an appointment within an available appointment window associated with one of the discounts.

One or more discount values can be assigned and/or selected 330. The one or more discount values can be assigned or selected 330 to motivate customer actions. One or more discount values can be assigned or selected 330 to motivate one or more customers to accept one appointment window over other available appointment windows. The discount value for a given near term available appointment window can be assigned and/or selected to be greater than a discount offered for another available appointment window. For example, if there is an available appointment window on the next business work day and there is a desire to fill that available appointment window over other available appointment windows 320, a discount of some percentage value can be assigned or selected for the available appointment window on the next business work day versus a lower and/or zero discount value for other future available appointment windows 320. The discounts that can be assigned or selected 330 can include percentage discounts or any discount imaginable including patient referral discounts and/or waiving and/or reduction of fees and/or costs for current and/or future services that might be offered to the customer that accepts the available appointment window associated with the given discount. Other appointment window discounts can be utilized including but not limited to discounted or free product offerings, discounted or free service offerings, and/or any other discounted or free offering desired.

A prophetic example can include, for a given future Wednesday there can be a 1:00 PM to 1:30 PM available appointment window. The one or more computers 110, with reference to FIGS. 1 and 2, can communicate with the one or more existing and/or potential customers, utilizing the wired 125 and/or wireless 140 sources, to inform them of the available appointment window and the one or more associated appointment window specific discounts. The communications can take place via e-mail and/or Short Messaging Services (SMS) and/or other known techniques. The one or more appointment window specific discounts can be redeemed by a particular customer after the customer agrees to set an appointment during the 1:00 PM to 1:30 PM appointment window associated with at least one of the appointment window specific discounts and the customer partakes in the scheduled appointment, thus incurring professional and other fees and costs that can be reduced by the amount of the discount.

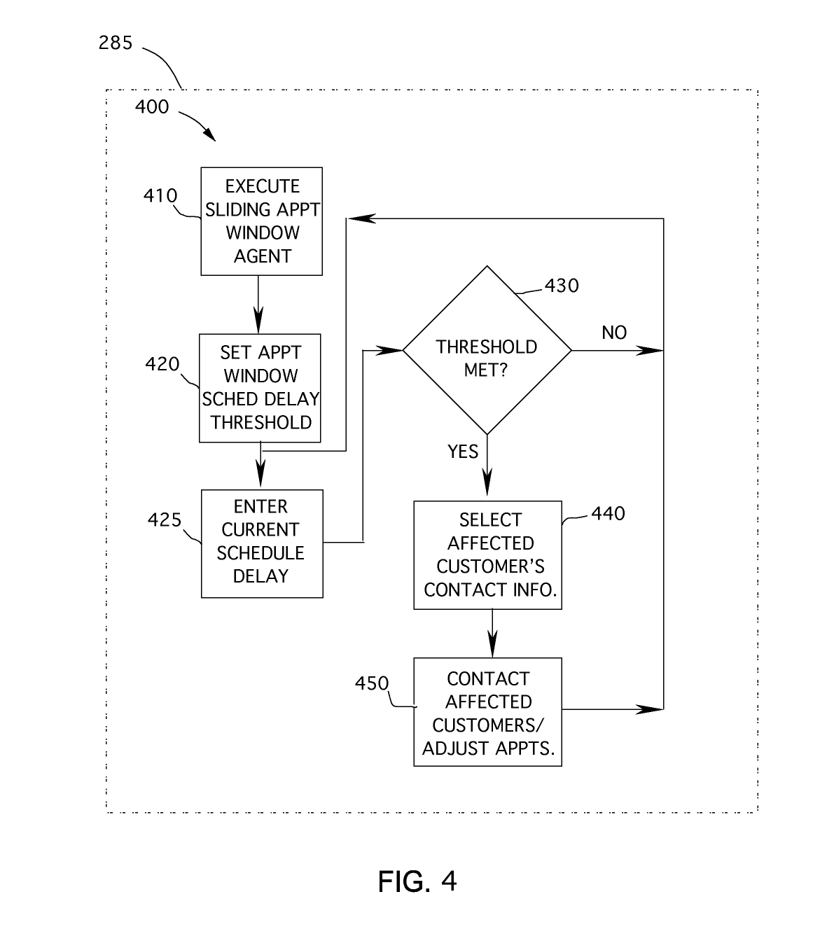

FIG. 4 depicts an illustrative flow diagram 400 for communicating appointment scheduling delays and schedule adjustments, according to one or more embodiments. The sliding appointment window agent 285 can be user executed 410 to discretely or continuously determine schedule variances in customer appointments due to delays in the completion of appointments and/or the early completion of appointments. For example, if a doctor or dentist is running one hour late for appointments on a given day, those affected customers 440 with future appointments on that given day can be notified 450 about the doctor's or dentist's intra-day schedule delays, and the customers with future appointments 440 can have their appointments rescheduled to a future available appointment window and/or all appointments windows for the affected customers 450 can be slid to a later time to accommodate the schedule delays.

The user can set one or more appointment window schedule delay thresholds 420 for determining when to notify customers about intra-day schedule changes. For example, the threshold can be set to 15, 20, 25, 30, 35, 40, 45, 50, or 55 minutes, or 1, 2, 3, or 4 hours, or to any time increment. The schedule delay threshold 420 can be varied over time or can be static.

The user can enter one or more current intra-day schedule delays 425. The one or more current intra-day schedule delays 425 can be in terms of seconds, minutes, hours, or any combination of time intervals associated with the measurement of time for the remainder of a given work day. The one or more current intra-day schedule delays 425 can be compared to the one or more appointment window schedule delay thresholds 420. If any one of the one or more current intra-day schedule delays 425 are greater than any one of the one or more appointment window schedule delay thresholds 420, the schedule delay threshold is met 430. If the schedule delay threshold is met 430, the current intra-day schedule delay 425 that met the schedule delay threshold 430 can be added to the then current local time to determine which future appointment windows are affected by the current intra-day schedule delay 425. The affected future appointment windows can be those future appointment widows that occur after the current local time plus the current intra-day schedule delay 425.

The contact information for one or more customers associated with each of the future appointment windows affected by the current intra-day schedule delay can be selected 440. One or more communications or messages 450 can be sent to the one or more customers associated with each of the future appointment windows affected by the current intra-day schedule delay 425 to inform the one or more customers associated with the affected future appointment windows about the current intra-day schedule delay 425.

The one or more messages can be sent via e-mail, short message service (SMS) or any known messaging techniques. The message can inform the one or more customers about the delay and can request the customer to accept a new appointment window later in the given day or on another day. For example, if a particular day's appointment windows are delayed by two hours, one or more messages can be sent to the affected customers 440 instructing them to come two hours later than planned due to schedule delays and/or to contact the business to reschedule their appointment if they desire. A confirmation of receipt of the notification of the intra-day schedule delay from the one or more customers associated with the future appointment windows affected by the current intra-day schedule delay of receipt of the notification of the intra-day schedule delay can be received. One or more alternative appointment windows can be communicated or sent to the one or more customers associated with the future appointment windows affected by the current intra-day schedule delay. Each of the one or more customers associated with the future appointment windows affected by the current intra-day schedule delay can accept at least one of the one or more alternative appointment windows. The method of claim 9, further comprising receiving, by the computer, a confirmation from the one or more customers associated with the future appointment windows affected by the current intra-day schedule delay of receipt of the schedule delay.

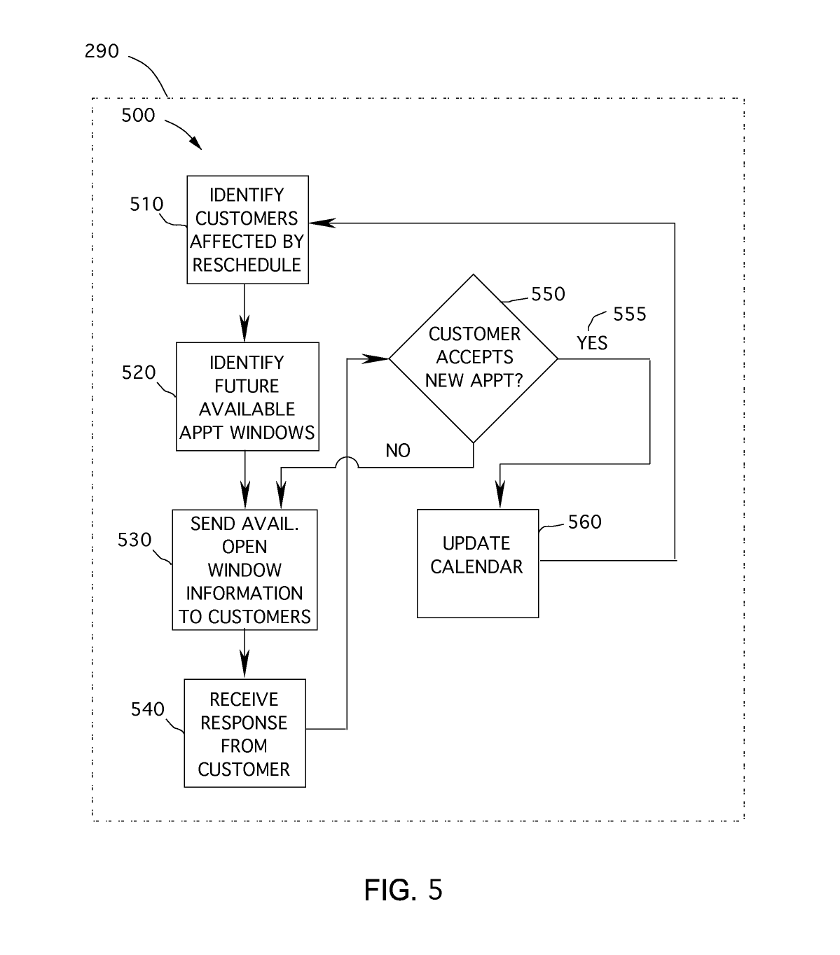

FIG. 5 depicts an illustrative flow diagram 500 for providing rescheduling of calendar appointments in the event of cancellations, according to one or more embodiments. Two or more consecutive schedule windows can be canceled to create two or more consecutive canceled schedule windows. The rescheduling agent 290 can autonomously reschedule the two or more consecutive canceled schedule windows. The rescheduling agent 290 can identify 510 each customer that is associated with each of the two or more consecutive canceled schedule windows and communicate with or send one or more messages about the cancellation to each customer associated with each of the two or more consecutive canceled schedule windows. The one or more messages can be sent via e-mail, short message service (SMS) or any known messaging techniques. The one or more messages can include information about one or more future open available schedule windows 530. At least one of the customers associated with the two or more consecutive canceled schedule windows can respond 540 to the one or more messages to accept or reject 550 the one or more future open available schedule windows. If the at least one customer that responded 540, accepts 555 one of the one or more future open available schedule window, the calendar can be updated 560 to include the at least on customer in the accepted 555 one or more future open available schedule window. For example, if an entire days worth of appointments have to be rescheduled due to an emergency, the rescheduling agent 290 can identify affected customers 510, identify 520 one or more future available appointment windows, communicate with or send information to 530 each particular customer affected by the cancellations the one or more future available appointment windows, receive at least one response from at least one of the customer 540 that the new appointment is accepted by that customer 550, and update the calendar 560 with the new appointment information for that particular customer.

The available appointment windows 520 can be sent 530 to each particular customer based on the appointment windows each particular customer had prior to the cancellations. For example, if the first appointment affected by the cancellations was set for 9:00 AM on a Monday and the second appointment affected by the cancellations was set for 10:00 AM on that Monday, the first identified available appointment window 520 can be communicated first to the patient who had the 9:00 AM appointment and if not accepted by that patient then sent to the patient who had the 10:00 AM appointment. The patient who had the 9:00 AM appointment can be sent each identified available appointment windows 520 after the first identified available appointment window until the patient who had the 9:00 AM appointment accepts one of the identified available appointment windows 520. The process can be repeated for the patient who had the 10:00 AM appointment. The process can be repeated for every patient affected by the cancellation of the two or more consecutive appointment windows. Other variations on offering patients future available schedule windows can be utilized based on any known factors including patient preferences, required appointment window length, and/or any factor known and/or convenient to the user.

Embodiments of the present disclosure further relate to any one or more of the following paragraphs:

1. A computer-implemented method for filling one or more available appointment windows, the method including: communicating, by a computer, one or more available appointment windows to one or more existing and/or potential customers; wherein at least one appointment window specific discount is associated with at least one of the one or more available appointment windows; receiving, by the computer, an acceptance by one or more of the existing and/or potential customers of one or more of the available appointment windows associated with the at least one appointment window specific discount; reserving on a first received basis, by the computer, the one or more appointment windows associated with the at least one appointment window specific discount for the one or more existing and/or potential customers from whom the acceptance was received; communicating, by the computer, to each of the one or more existing and/or potential customers, from whom the acceptance was received, confirmation of each of the one or more appointment windows associated with the at least one appointment window specific discount that were reserved for each of the one or more existing and/or potential customers; and associating, by the computer, each of the at least one appointment window specific discounts with a customer account corresponding to each of the one or more existing and/or potential customers who accepted and received a reservation for one or more of the appointment windows associated with the at least one appointment window specific discount.

2. The method according to paragraph 1, further including communicating to the customer, by the computer, one or more customer information forms to be completed by the customer in preparation for at least one accepted appointment window.

3. The system according to paragraph 1 or 2, wherein communicating, by the computer, one or more available appointment windows to one or more existing and/or potential customers is performed via e-mail.

4. The system according to paragraphs 1 to 3 wherein communicating, by the computer, one or more available appointment windows to one or more existing and/or potential customers is performed via SMS.

5. The system according to paragraphs 1 to 4 wherein communicating, by the computer, one or more available appointment windows to one or more existing and/or potential customers is performed via e-mail in combination with SMS.

6. A computer-implemented method for managing a practice, the method including: generating, by a computer, a scheduling calendar having one or more appointment windows displayed to a user on an output device; scheduling, by the computer, customer appointments within the one or more appointment windows; communicating, by the computer, one or more available appointment windows to one or more existing and/or potential customers; wherein at least one appointment window specific discount is associated with at least one of the one or more available appointment windows; receiving, by the computer, an acceptance by one or more of the existing and/or potential customers of one or more of the available appointment windows associated with the at least one appointment window specific discount; reserving on a first received basis, by the computer, the one or more appointment windows associated with the at least one appointment window specific discount for the one or more existing and/or potential customers from whom the acceptance was received; communicating, by the computer, to each of the one or more existing and/or potential customers, from whom the acceptance was received, confirmation of each of the one or more appointment windows associated with the at least one appointment window specific discount that were reserved for each of the one or more existing and/or potential customers; and associating, by the computer, each of the at least one appointment window specific discounts with a customer account corresponding to each of the one or more existing and/or potential customers who accepted and received a reservation for one or more of the appointment windows associated with the at least one appointment window specific discount.

7. The system according to paragraphs 6, wherein the one or more appointment windows are displayed within an internet browser window displayed on the output device.

8. The system according to paragraphs 6 or 7, wherein communicating, by the computer, one or more available appointment windows to one or more existing and/or potential customers is performed via e-mail.

9. The system according to paragraphs 6 to 8, wherein communicating, by the computer, one or more available appointment windows to one or more existing and/or potential customers is performed via SMS.

10. The system according to paragraphs 6 to 9, wherein communicating, by the computer, one or more available appointment windows to one or more existing and/or potential customers is performed via e-mail in combination with SMS.

11. The system according to paragraphs 6 to 10, further including communicating to the customer, by the computer, one or more customer information forms to be completed by the customer in preparation for at least one accepted appointment window.

12. A system for managing a practice, the system including: a processor; a non-transitory memory in electronic communication with the processor; and one or more code sets stored in the non-transitory memory, the code sets being executable by the processor to: generate a scheduling calendar having one or more appointment windows displayed on an output device; schedule customer appointments within the one or more appointment windows; communicate one or more available appointment windows associated with at least one appointment window specific discount to one or more existing and/or potential customers; receive an acceptance by one or more of the existing and/or potential customers of one or more of the available appointment windows associated with the at least one appointment window specific discount; reserve on a first received basis the one or more appointment windows associated with the at least one appointment window specific discount for the one or more existing and/or potential customers from whom the acceptance was received; communicate to each of the one or more existing and/or potential customers, from whom the acceptance was received, confirmation of each of the one or more appointment windows associated with the at least one appointment window specific discount that were reserved for each of the one or more existing and/or potential customers; and associate each of the at least one appointment window specific discounts with a customer account corresponding to each of the one or more existing and/or potential customers who accepted and received a reservation for one or more of the appointment windows associated with the at least one appointment window specific discount.

13. The system according to paragraphs 12, further including the code sets being executable by the processor to display the one or more appointment windows within an internet browser window displayed on the output device.

14. The system according to paragraphs 12 or 13, wherein communicating one or more available appointment windows to one or more existing and/or potential customers is performed via e-mail.

15. The system according to paragraphs 12 to 14, wherein communicating one or more available appointment windows to one or more existing and/or potential customers is performed via SMS.

16. The system according to paragraphs 12 to 15, wherein communicating one or more available appointment windows to one or more existing and/or potential customers is performed via e-mail in combination with SMS.

17. The system according to paragraphs 12 to 16, further including the code sets being executable by the processor to communicate to the customer one or more customer information forms to be completed by the customer in preparation for at least one accepted appointment window.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention can be devised without departing from the basic scope thereof, and the scope thereof is determined by the claims that follow.

What is claimed is:

1. A computer-implemented method for filling one or more available appointment windows, the method comprising:
communicating, by a computer, one or more available appointment windows to one or more existing and/or potential customers;
wherein at least one appointment window specific discount is associated with at least one of the one or more available appointment windows;
receiving, by the computer, an acceptance by one or more of the existing and/or potential customers of one or more of the available appointment windows associated with the at least one appointment window specific discount;
reserving on a first received basis, by the computer, the one or more appointment windows associated with the at least one appointment window specific discount for the one or more existing and/or potential customers from whom the acceptance was received;
communicating, by the computer, to each of the one or more existing and/or potential customers, from whom the acceptance was received, confirmation of each of the one or more appointment windows associated with the at least one appointment window specific discount that were reserved for each of the one or more existing and/or potential customers; and
associating, by the computer, each of the at least one appointment window specific discounts with a customer account corresponding to each of the one or more existing and/or potential customers who accepted and received a reservation for one or more of the appointment windows associated with the at least one appointment window specific discount.

2. The method of claim 1, further comprising communicating to the customer, by the computer, one or more customer information forms to be completed by the customer in preparation for at least one accepted appointment window.

3. The method of claim 1, wherein communicating, by the computer, one or more available appointment windows to one or more existing and/or potential customers is performed via e-mail.

4. The method of claim 1, wherein communicating, by the computer, one or more available appointment windows to one or more existing and/or potential customers is performed via SMS.

5. The method of claim 1, wherein communicating, by the computer, one or more available appointment windows to one or more existing and/or potential customers is performed via e-mail in combination with SMS.

6. A computer-implemented method for managing a practice, the method comprising:
generating, by a computer, a scheduling calendar having one or more appointment windows displayed to a user on an output device;
scheduling, by the computer, customer appointments within the one or more appointment windows;
communicating, by the computer, one or more available appointment windows to one or more existing and/or potential customers;
wherein at least one appointment window specific discount is associated with at least one of the one or more available appointment windows;
receiving, by the computer, an acceptance by one or more of the existing and/or potential customers of one or more of the available appointment windows associated with the at least one appointment window specific discount;
reserving on a first received basis, by the computer, the one or more appointment windows associated with the at least one appointment window specific discount for the one or more existing and/or potential customers from whom the acceptance was received;
communicating, by the computer, to each of the one or more existing and/or potential customers, from whom the acceptance was received, confirmation of each of the one or more appointment windows associated with the at least one appointment window specific discount that were reserved for each of the one or more existing and/or potential customers; and
associating, by the computer, each of the at least one appointment window specific discounts with a customer account corresponding to each of the one or more existing and/or potential customers who accepted and received a reservation for one or more of the appointment windows associated with the at least one appointment window specific discount.

7. The method of claim 6, wherein the one or more appointment windows are displayed within an internet browser window displayed on the output device.

8. The method of claim 6, wherein communicating, by the computer, one or more available appointment windows to one or more existing and/or potential customers is performed via e-mail.

9. The method of claim 6, wherein communicating, by the computer, one or more available appointment windows to one or more existing and/or potential customers is performed via SMS.

10. The method of claim 6, wherein communicating, by the computer, one or more available appointment windows to one or more existing and/or potential customers is performed via e-mail in combination with SMS.

11. The method of claim 6, further comprising communicating to the customer, by the computer, one or more customer information forms to be completed by the customer in preparation for at least one accepted appointment window.

12. A system for managing a practice, the system comprising:
a processor;
a non-transitory memory in electronic communication with the processor; and
one or more code sets stored in the non-transitory memory, the code sets being executable by the processor to:
generate a scheduling calendar having one or more appointment windows displayed on an output device;
schedule customer appointments within the one or more appointment windows;
communicate one or more available appointment windows associated with at least one appointment window specific discount to one or more existing and/or potential customers;
receive an acceptance by one or more of the existing and/or potential customers of one or more of the available appointment windows associated with the at least one appointment window specific discount;
reserve on a first received basis the one or more appointment windows associated with the at least one appointment window specific discount for the one or more existing and/or potential customers from whom the acceptance was received;
communicate to each of the one or more existing and/or potential customers, from whom the acceptance was received, confirmation of each of the one or more appointment windows associated with the at least one appointment window specific discount that were reserved for each of the one or more existing and/or potential customers; and
associate each of the at least one appointment window specific discounts with a customer account corresponding to each of the one or more existing and/or potential customers who accepted and received a reservation for one or more of the appointment windows associated with the at least one appointment window specific discount.

13. The system of claim 12, further comprising the code sets being executable by the processor to display the one or more appointment windows within an internet browser window displayed on the output device.

14. The system of claim 12, wherein communicating one or more available appointment windows to one or more existing and/or potential customers is performed via e-mail.

15. The system of claim 12, wherein communicating one or more available appointment windows to one or more existing and/or potential customers is performed via SMS.

16. The system of claim 12, wherein communicating one or more available appointment windows to one or more existing and/or potential customers is performed via e-mail in combination with SMS.

17. The system of claim 12, further comprising the code sets being executable by the processor to communicate to the customer one or more customer information forms to be completed by the customer in preparation for at least one accepted appointment window.
